(19) United States
(12) Patent Application Publication
(10) Pub. No.: US 2006/0191324 A1
(43) Pub. Date: Aug. 31, 2006

(54) Automated system for detection and control of water leaks, gas leaks, and other building problems

(76) Inventors: Michael Garabedian, Newton, MA (US); Patrick Garabedian, Rutland, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/065,865

(22) Filed: Feb. 25, 2005

(51) Int. Cl. G01M 3/04; G08B 21/00

(52) U.S. Cl. 73/40; 340/605

(57) ABSTRACT

A leak detection and control system provides for remote user control of devices in responding to detected leaks of other problems. A plurality of sensors and sensor types are used at various locations in a building where leaks are likely to occur. Upon detection of a leak, a sensor sends an RF signal identifying the sensor. A controller receives the RF signal and performs actions associated with the identifier for the sensor. Actions may include selectively closing or opening valves and electrical connections. Notifications are also sent by the system to building owners, occupants, maintenance personnel or operators. An operator can contact the controller from a remote location via a telephone system or a network to check status and to activate devices.

### BACKGROUND OF THE INVENTION

1. Field of the Invention

The present invention relates to a system for detecting water leaks, gas leaks and other building problems and automatically acting to prevent significant damage. More particularly, it relates to a system for monitoring multiple locations and selective automated and remote control of building devices based upon detected leak locations.

2. Discussion of Related Art

Buildings include networks pipes, valves, and other mechanized devices for conveying liquids and/or gases, such as water, oil, natural gas, and propane. The parts in these networks often require periodic maintenance. Not infrequently, there is a malfunction and undesirable water, gas or other substances leak into the building. These leaks present a health hazard to the occupants and cause significant damage to the building and its contents. The type and location of a malfunction or failure cannot be predetermined. Thus, in order to limit damage and the safety hazard, a leak needs to be responded to, stopped, and cleaned up quickly. Often, the occurrence of a leak is not noticed until sufficient water or other substance has accumulated in an occupied area. Since the network of pipes is generally located out of sight, a substantial leak, with accompanying damage, will have occurred before its occurrence is detected. An appropriate response often includes an expensive, emergency visit from a plumber or other service professional to correct any problems.

In addition to the network of pipes, the liquids or gases terminate at various fixtures and appliances. Such fixtures and appliances include hot water heaters, washing machines, dishwashers, radiators, sinks, commodes, ovens, stoves, fireplaces, refrigerators, etc. Failures also occur at the fixture or appliance which also may cause a leak. Failures within the network are often caused by ambient conditions which cause the water in certain pipes, such as pipes extending through or along poorly-insulated outside walls, to freeze, bursting the pipes. Serious flooding is also often caused by inadvertently leaving a faucet in a sink or tub running with the associated drain blocked.

Additionally, in buildings which are heated, there is a constant danger that lethal carbon monoxide will be generated from improper combustion of the fuel source. Carbon monoxide has no odor and is not typically detected by building occupants.

A quick response to a leak or other problem can significantly limit the damage. Thus, automated systems have been developed to detect and respond to leaks. Such systems include one or more sensors placed at a location of a likely leak. The sensors may activate a visual or audio alarm located at the sensor or at a remote location. Such system may also respond to detected leaks by shutting off valves to prevent further flow of the liquid or gas to the area of the leak.

While the occurrence of a leak cannot be predicted, locations where leaks are likely to occur can be predicted. For example, sensors can be placed near or under appliances likely to develop leaking conditions, under pipes extending through or near exterior walls likely to promote freezing conditions, and at low points in bathrooms where sinks and tubs may be left with water running. While the locations of potential leaks can be determined, some of these locations, such as the places where pipes run through or near exterior walls, are not easily accessed. Such locations may, for example, be in crawl spaces under floors or in attics. Thus, sensing systems generally account for the difficulties in sensor placement, leak response locations, alarm placement, etc. A number of patents relate to different types of systems and features useful in detecting and responding to leaks.

While many different sensor and control systems are known, none of such systems provide complete protection under a variety of conditions. In particular, all such systems include one or more sensors for detecting leaks and provide a single response for detection. The response may include a set of different types of actions, such as activation of different types of alarms, indications of locations, and activation of valves to stop leaks. Nevertheless, known systems are limited to a single predetermined response to all detected conditions. They cannot provide alternative responses based upon the type or location of a sensor detecting a leak.

Additionally, such known systems still require substantial human involvement to resolve the leak. Once a leak is detected, the system merely shuts off water to the building or device. The leak needs to be corrected before the water can be turned back on. Typically, this necessitates a call to a service professional, such as a plumber. The service professional must visit the site, locate the leak, and fix it before normal conditions are restored. Sometimes, the service professional must take some initial action before repair work can commence. For example, with a large leak, water may need to be pumped out of a room or basement before repair work can start. Under such a situation, a plumber will start a pump, such as a sump pump, to remove the water. The service professional will return later once the water has been removed.

In another example, carbon monoxide may be present when a water heater or boiler has a problem. The detection system may also include a detector for carbon monoxide, which caused the shutdown action. A service professional cannot simply enter a room with the known or possible presence of carbon monoxide. A first step is to ventilate the room. The service professional may take actions to open a room up, and then return later once the risk of carbon monoxide has been removed.

A leak often occurs outside of normal business hours. In addition to a service charge, service professionals usually charge extra for correcting problems during such times. Even with an automatic shutdown system, the service professional may need to ensure that proper corrective action has been taken to stop the leak. While the leak can be repaired later, additional charges for off hours verification may be required.

Large and multiunit buildings, such as offices, hotels and apartment buildings, typically employ a staff of service professionals to correct detected problems. Since response time is important to correct leaks, one or more staff are typically present at the building at all times. In such buildings, locating a leak can be difficult due to the large number of possible leaking locations. Similarly, due to the large number of valves, the correct valve for shutting off a leak can also be difficult to determine.

### SUMMARY OF THE INVENTION

The present invention is a system for remotely monitoring and responding to different types of detected leaks. It includes a plurality of sensors at locations of possible leaks. The sensors transmit signals upon leak detection. A control device receives the transmitted signal and determines an appropriate response to the detected leak. The control device functions to perform the desired response. According to aspects of the invention, the functions may include combinations of shutting off water or gas valves, turning off electrical devices, activating pumps, activating alarms, and notifying users, owners, or repairmen of the detected leak. The system further includes mechanisms for notifying appropriate people of the detected leak. According to various aspects of the invention, such mechanisms include an autodialer and a computer.

According to another aspect of the invention, the system includes a remote monitoring station. The remote monitoring station allows a user to determine the location of the sensor which detected the leak and the status of the response. The remote monitoring station also allows a user to take additional corrective action. The remote monitoring station may cause the control device to open valves, turn on pumps or fans, open ventilation doors, etc. According to various aspects of the invention, the remote monitoring station may be a telephone, cellular phone, computer, or handheld computing device.

According to another aspect of the invention, the system includes at least one video camera for providing an image of a portion of a building. The image is accessible from the remote monitoring station to check the current status of the building.

### BRIEF DESCRIPTION OF THE DRAWINGS

FIG. 1 illustrates a leak detection and control system according to an embodiment of the present invention.

### DETAILED DESCRIPTION

The present invention is a “smart” system allowing multiple possible responses to detection of leaks and remote control of system parts. The present applicants filed on even date herewith a U.S. Patent Application entitled “Automated System For Detection And Control Of Water Leaks, Gas Leaks, And Other Building Problems”, incorporated herein by reference in its entirety, which relates to a system for detecting and selectively responding to leaks. That system includes a plurality of sensors for detecting leaks. Each sensor includes an identifier. When a leak is detecting, the sensor transmits a signal, including its identifier, to a control device. The control device performs different actions based upon the identifier of the sensor which detected a leak. The present invention extends this system to provide additional user control. Specifically, the system of the present invention connects the control device to a computer or other processing system. The computer or processing system can be used to execute any of the actions of the control device. Furthermore, the computer or processing system may be connected through one or more networks to allow control from remote locations.

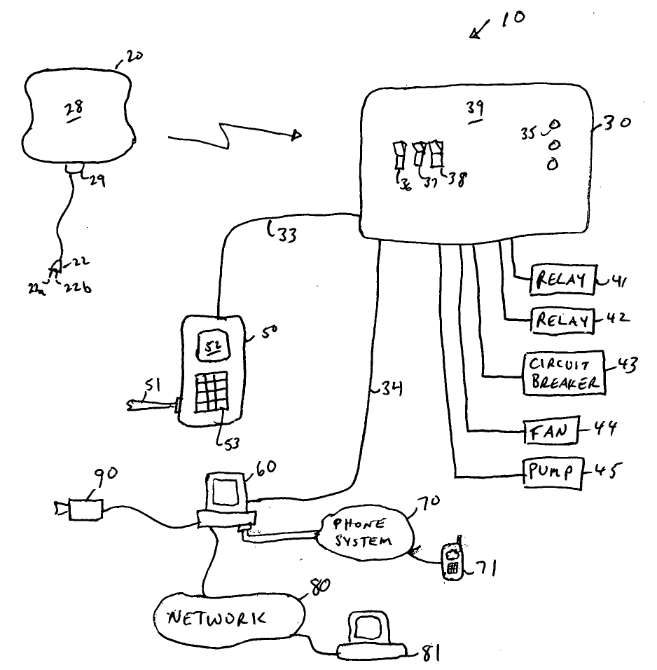

According to an embodiment of the invention illustrated in FIG. 1, the system 10 includes several types of devices, a plurality of sensors 20 (one shown), a controller 30, and a computer 60. The sensors 20 are placed at locations of possible leaks. The controller 30 is placed remotely from the sensors and preferably at a location where responsive actions should be taken, such as in a basement where shut-off valves are located. The computer 60 may be placed near the controller 30 or may be placed in a control room away from the controller 30. When a sensor 20 detects a leak, it sends a signal to the controller 30. Upon receipt of a signal from a sensor 20, the controller 30 takes appropriate action.

The sensors 20 include a power source and electronics in a housing 28. Preferably, the housing 28 is water tight to protect the components of the sensor 20 from leaks. Of course, if the sensor 20 is used for sensing leaks of other liquids or gases, the housing 28 should be impervious to such liquids or gases. A sensor lead 21 extends from the housing 28. The sensor lead 21 may be wired directly into the housing 28. According to a preferred embodiment of the invention, the sensor lead 21 connects to a port 29 in the sensor 20. By using a port 29 in the sensor 20, different types of sensor leads 21 may be used in connection with a sensor to provide for different types of leak detection without the need for multiple kinds of sensors. According to an embodiment of the invention, the sensors 20 are of a type which detects a leak through completion of an electrical circuit. The output port 29 includes two connectors. Completion of an electrical circuit between the two connectors indicates the presence of a leak. The sensor lead 21 operates to complete the electrical circuit as the result of a leak or other sensed event.

The sensor lead 21 illustrated in FIG. 1 includes a detector tip 22 which creates a water leak detector. The detector tip 22 includes two electrodes 22a, 22b. Wires in the lead 21 connect each of the electrodes 22a, 22b to the two connectors of the port 29. The detector tip 22 is positioned at a location where a water leak may occur. The electrodes 22a, 22b are positioned so that they will contact water from the leak. The leaking water provides the electrical connection between the electrodes 22a, 22b which completes the electrical circuit from the sensor. The lead 21 is of sufficient length so that the lead can be easily positioned at a water leak location. Sensor leads 20 may have different lengths for different applications. Preferably, the sensor 20 is mounted on a wall or in a crawl space near a location of a possible leak. Since the housing 28 is water tight, the positioning of the sensor 20 need not be out of the area where a leak occurs. While FIG. 1 illustrates a particular type of sensor lead 21, any know sensor lead may be used, including cable sensors, stainless steel sensor tape, and cloth sensor tape. Sensors may also be used to detect conditions other than leaks, such as temperatures and carbon monoxide.

As illustrated in FIG. 1, the controller 30 includes a housing 39 for containing circuitry. Since the controller need not be placed near the location of a leak, the housing 39 may not be water tight. Furthermore, since various connections, switches and indicator lamps are used in the controller 30, making the housing 39 water tight would be unnecessarily expensive due to the use of multiple seals and sealing surfaces. The controller 30 includes a plurality of output ports. The output ports are used to output signals for controlling the states of valves or other mechanical and electrical devices. The controller 30 can be used to control any number and types of devices. As illustrated in FIG. 1, the controller 30 may control valves 41, 42, circuit breakers 43, fans 44 and pumps 45. The controller 30 can send signals to turn on or off any type of device. Preferably, the control signals for all types of devices are identical. In this manner, the controller 30 has a plurality of identical output ports. Each desired action is associated in the controller 30 with one or more of the output ports. When an action is to be performed, the control signal is sent to the output port. The type of action performed merely depends upon the device attached to that output port.

The controller 30 includes one or more LED indicator lights 35 for identifying the status or condition of the controller 30 and the system 10. For example, the LEDs 35 may be used to indicate that one or more valves have been shut off. The controller 30 further includes a plurality of switches 36, 37, 38 for manually performing various functions. For example, the controller 30 may include an audio alarm. One of the switches 36, 37, 38 may be used to shut off the audio alarm. In this manner, an operator or repairman may acknowledge and stop an alarm without having to first correct the condition which resulted in the alarm. Switches 36, 37, 38 may also be used for opening or closing the controlled valves, irrespective of the status of the controller. Thus, the controller 30 may be used to manually shut off the water supply, when a leak has not been detected, so that some service may be performed. Alternatively, the controller 30 may be used to reopen the water supply line after a leak detection by using the switches 36, 37, 38.

Upon receipt of a signal from a sensor 20, the controller sends a control signal through any one or any set of output ports to act on the appropriate device. Which devices are acted upon by the controller depends upon the nature and location of the detected leak or condition. Each sensor 20 includes an identifier. Each identifier within the system is associated with a desired action or actions within the controller 30. When a sensor transmits a signal upon detection of a leak or other condition, the identifier for that sensor 20 is included in the signal. The controller determines the identifier in the signal and performs the actions associated with that identifier. Thus, the system of the present invention can provide varied responses to different detected conditions.

For example, as is known in prior art systems, water sensors 20 may be placed at locations throughout a building where leaks are likely to occur. A controllable valve may be placed on the water input line to the building. Upon detection of a water leak by any of the sensors 20, a signal which includes an identifier is sent from the sensor 20 to the controller 30. The controller 30 determines that the identifier corresponds to a water sensor and sends a control signal through an output port to the controllable valve 41, 42 turning off all water to the building.

While shutting off the water may be sufficient for pipe, fixture or dishwasher leaks, it is not a proper response to a water heater leak. In addition to shutting off the water, the water heater needs to be completely shut down. This includes shutting off the power to the water heater. Shutting off the power may include shutting off gas to the heater as well as electricity to the water heater control, so that it doesn't try to turn on the water heater without water or gas. Prior art systems could not accommodate a water heater with a system for detecting general water leaks. In order to fully respond to a water heater leak, a separate system would be used for the water heater. This, of course, would necessitate a second valve in the water input line for shutting off water.

The system of the present invention may also be used to monitor and control buildings with multiple units. Sensors can be placed at likely locations for leaks throughout all of the units in the building. A single controller 30 is placed near the water source lines for all of the units, typically in the basement of the building. When a leak is detected by a sensor, the identifier for that sensor corresponds in the controller 30 to one of the units. The valve corresponding to only that unit is shut off. The water supply to the other units are not affected.

By using different kinds of sensors, the flexibility of the system of the present invention can be utilized to protect against different types of threats. The system can also turn on devices as well as turning them off. Thus, it can respond to conditions to take action as well as to stop something causing damage. For example, the system may turn on a sump pump to remove accumulated water, whether from a leak or from a flooding condition.

Temperature sensors may be used on pipes which might freeze. When the temperature sensor detects a low temperature condition, the controller 30 may respond by turning on a heater, either a space heater or a pipe heater, to increase the temperature of the pipe. Temperature sensors may also be used to control an air conditioning system to prevent excessive temperatures which may cause mold or mildew growth. Humidity sensors may also be used in connection with air conditioner control to prevent unwanted mold or mildew. Furthermore, electrical sensors may be used to determine when power has been lost to the building. Without power, attempting to turn on a heater or an air conditioner to correct a detected problem would be futile. Different actions can be accommodated by the system of the present invention depending upon these detected conditions.

According to an embodiment of the present invention, the system 10 provides notification of the detected conditions through a variety of mechanisms. The controller 30 includes an audio alarm which is activated when an abnormal condition is detected. It may also include a visual alarm, either using the LEDs or another light (not shown). However, if the controller 30 is not placed in a location of consistent personnel presence, alarms are not helpful.

The controller 30 may be connected by an output 33 to an autodialer 50. Autodialer 50 may be of conventional design. It includes a keypad 53 for inputting and storing numbers to be called. It also includes a display 52. The autodialer 50 connected to a telephone line 51 for the building. The autodialer is programmed to telephone one or more telephone numbers upon receipt of a signal from the controller 30. The numbers may be prestored in the autodialer 50 using the keypad 53 or may be transmitted by the controller 30. When a telephone connection is made, the autodialer 50 plays a recorded message. The message may be prerecorded by the user or may be transmitted from the controller 30. The controller 30 can be used to provide case specific notifications using the autodialer 50. For example, the controller 30 may have the autodialer 50 telephone a plumber when a water leak is detected and the gas company when a gas leak is detected. The autodialer 50 may also telephone the building owner or manager.

According to an embodiment of the present invention, the controller 30 may be connected to another device for notification purposes. An autodialer may be used to call a phone or pager. Other devices can sent text messages or emails for notifying owners or service personnel of detected conditions.

Additional control is proved in the system of the present invention by connecting the controller 30 to a computer 60. According to other embodiments of the invention, a generally processing device may be used instead of a computer 60. As will be discussed below, the computer 60 connects to various systems for remote monitoring and control of the system. A processing device for connecting the controller 30 to the remote systems is sufficient for purposes of the present invention.

The connection 34 between the controller 30 and the computer 60 operates in both directions. When the controller 30 receives a signal from a sensor 20, information regarding that signal is sent to the computer 60. Such information would include the sensor identifier. Also, when the controller 30 takes an action, such as shutting off a valve, information regarding that action is also sent to the computer 60. Such information would identify the device acted upon and the action taken. The computer can also request information from the controller 30. Such information may include the status of each of the devices attached to the controller 30, i.e. whether they are open (on) or closed (off). Notification of sensed events, such as the presence of water, can be displayed on the computer screen based upon information sent by the controller.

The computer 60 is programmed to allow monitoring of the entire system. According to an embodiment of the invention, such programming includes diagrams or maps of the building with the locations of the sensors, valves, and other controlled devices. The diagrams may be two dimensional or three dimensional. When a sensor 20 detects a leak or other condition, the information regarding that sensor is sent through the controller 30 to the computer 60. The computer can provide to a user the appropriate map or diagram with an indication of the location of the sensor. The user is able to determine the exact location of a leak from the computer. Since the controller 30 also provides information to the computer 60 regarding actions taken in response to the sensor, the valves or other devices activated can be displayed on the computer diagram as well. Thus, the user can verify that appropriate actions have been completed to stop a leak.

Additionally, according to an embodiment of the invention, a video camera 90 can be connected to the computer. The video camera 90 is placed so that sensor locations can be viewed at the computer. The video camera 90 may also be controllable from the computer as to direction or range of view. The video camera 90 allows a user at the computer to check the status of a room where a leak or other condition has occurred. The user can determine whether other action is required, such as pumping out standing water from a leak.

A user of the system of the present invention may also use the computer 60 to control devices connected to the controller 30 in order to aid in the repair process. All of the devices connected to the controller 30 are controllable. Devices, such as a pump or fan, may be used principally for the repair process and not automatically controlled by the system. In this manner, the user does not have to be physically present at the leak or control location to start repairs. For example, upon detection of a high level of carbon monoxide in a boiler room by an appropriate sensor 20, the system would automatically shut off the gas and water to the boiler. A user is notified of the detected condition and actions at the computer 60. The user may check the status of the room, and may turn on a fan or open vents using the controller 30 to clear the high level of carbon monoxide before entering the room to investigate the cause. The sensor 20 can also be used to determine whether the carbon monoxide has been purged before repairmen enter the room. Similarly, a user may utilize the video camera 90 to check the status of a room following detection of a leak. If standing water is present, the user may turn on a pump connected to the controller 30 through instructions from the computer.

According to another embodiment of the present invention, a system may include a plurality of controllers 30 connected to a single computer 60. Each controller 30 would be associated with a set of sensors 20 and a set of controlled devices 41, 42, 43, 44, 45. By using plurality of controllers 30 multiple devices may be controlled without being limited by the number of outputs on the controller 30. All information regarding the system and multiple controllers can be retrieved from the computer 60.

According to another embodiment of the invention, the computer 60 is connected to a network for remote access and control. Preferably, the computer 60 is located in a maintenance room of the building. However, the maintenance room may not be occupied at all times. Notifications, information and control may need to occur at other locations. Thus, the computer 60 may be connected to a phone system 70 through a modem (not shown). The computer 60 can transfer information to a desired telephone 71 connected to the phone system 70. For example, in the event of a detected leak, the computer 60, upon notification from the controller 30, may call a stored cellular telephone number. The computer can be used in place of the autodialer for providing notifications. However, the computer can allow two way communication with the phone 71. The user can check the status of other parts of the system and can initiate actions through the phone 71 when contacted by the computer 60. Alternatively, a user may use a phone 71 to call the computer 60 for initiating action after receiving notifications from the autodialer or other source. Additionally, the computer may make use of other technologies to send and receive text messages, pager messages or other information through the phone system to perform the desired functions.

According to another embodiment of the invention, the computer 60 is connected to a computer network 80. The computer network may be a local area network within the building or part of a building, a wide area network, or a global network, such as the Internet. The network may be a private or public network. A remote computer 81 communicates through the network 80 to the computer 60. All information and control operations on computer 60 can be performed from computer 81. Computer 81 may be connectable to more than one computer 60 for monitoring and controlling multiple systems.

Having described at least one embodiment of the invention, various modifications, adaptations, additions and extensions will be readily apparent to those of skill in the art. Such modifications, adaptations, additions and extensions are considered to be within the scope of the invention, which is not limited except as to the claims hereto.

1. A system for remote monitoring and operation of components of a building, the system comprising:
a plurality of sensors, each sensor transmitting a respective signal upon occurrence of a sensed environmental condition within the building;
a plurality of actuators controlling operation of the building;
a controller, receiving signals from the plurality of sensors, selecting and operating at least one of the plurality of actuators based upon a signal from at least one of the plurality of sensors, and providing output information relating to signals from sensors and operated actuators; and
a processing system receiving and storing the output information from the controller.

2. The system for remote monitoring and operation of components of a building according to claim 1, wherein the processing system further comprises a display for displaying the location of sensors and actuators identified in the output information.

3. The system for remote monitoring and operation of components of a building according to claim 1, wherein the processing system includes means for providing a control signal to the controller, the control signal identifying an actuator to be operated; and
wherein the controller operates an actuator identified in a control signal from the processing system upon receipt of the control signal.

4. The system for remote monitoring and operation of components of a building according to claim 1, further comprising:
at least one video camera, positioned to view a portion of the building affected by at least one of the sensors and the actuators, and providing an output to the processing system; and
wherein the processing system includes a display for displaying the output of the video camera.

5. The system for remote monitoring and operation of components of a building according to claim 1, wherein the processing system includes:
a communications network;
a first processor connected to the controller and the communications network; and
a second processor connected to the communications network.

6. The system for remote monitoring and operation of components of a building according to claim 5, wherein the second processor includes a telephone and the communications network includes a telephone system.

7. The system for remote monitoring and operation of components of a building according to claim 5, wherein the second processor includes a computer and the communication network includes a computer network.

8. The system for remote monitoring and operation of components of a building according to claim 5, wherein the first processor receives the output information from the controller and transfers the output information to the second processor through the communications network.

9. The system for remote monitoring and operation of components of a building according to claim 5, wherein the second processor generates and transfers the control signal through the communications network to the first processor and the first processor transmits the control signal to the controller.

10. The system for remote monitoring and operation of components of a building according to claim 5, further comprising:
at least one video camera, positioned to view a portion of the building affected by at least one of the sensors and the actuators, and providing a video output to the first processor of the processing system; and
wherein the first processor transfers the video output through the communications network to the second processor; and
wherein the second processor includes a display for displaying the video output of the video camera.

11. A method for remote monitoring and operation of components of a building comprising the steps of:
associating each of the plurality of sensed environmental conditions with at least one of a plurality of actions relating to operation of the building;
sensing one of the plurality of sensed environmental conditions;
performing the at least one of the plurality of actions based upon the sensed condition; and
storing information relating to the one of the plurality of sensed environmental conditions and the at least on of the plurality of actions.

12. A method for remote monitoring and operation of components of a building according to claim 11, further comprising the step of displaying locations of the one of the plurality of sensed environmental conditions and the at least on of the plurality of actions.

13. A method for remote monitoring and operation of components of a building according to claim 11, further comprising the step of transferring the information to a remote device through a communications network.

14. A method for remote monitoring and operation of components of a building according to claim 13, further comprising the steps of:
receiving a control signal from the remote device through the communications network, the control signal identifying one of the plurality of actions; and
performing the one of the plurality of actions identified in the control signal.

15. A method for remote monitoring and operation of components of a building according to claim 13, wherein the remote device includes a telephone and the communications network includes a telephone system.

16. A method for remote monitoring and operation of components of a building according to claim 13, wherein the remote device includes a computer and the communications network includes a computer network.
